(19) United States
(12) Patent Application Publication
(10) Pub. No.: US 2026/0278163 A1
(43) Pub. Date: Sep. 17, 2026

(54) CONTEXT-BASED DYNAMIC PSEUDONYMIZATION AT THE NETWORK EDGE

(71) Applicant: Anonos IP LLC, Beaverton, OR (US)

(72) Inventors: Jeff Weishaupt, Lakeland, FL (US); Mark Little, Matthews, NC (US); Malcolm Gary LaFever, Lyons, CO (US)

(21) Appl. No.: 19/166,812

(22) PCT Filed: Mar. 28, 2024
(86) PCT No.: PCT/US2024/022006

§ 371 Date: Sep. 18, 2025

Related U.S. Application Data
(60) Provisional application No. 63/493,611, filed on Mar. 31, 2023.

(51) Int. Cl. G06F 21/62

(52) U.S. Cl. CPC G06F 21/6254

(57) ABSTRACT

Various systems and methods are disclosed herein that are configured to: execute a first web-based platform; receive, at the first web-based platform, a first dataset of cleartext values for pseudonymization (e.g., context-based pseudonymization); apply, at the first web-based platform, at least one pseudonymization technique to at least one datum in the first dataset to generate a first dataset; transmit, from the first web-based platform, the pseudonymized first pseudonymized dataset to a first software as a service (Saas) provider; receive, at the first web-based platform, a response from the first SaaS provider to a request from a user device, the response comprising the first pseudonymized dataset; relink, at the first web-based platform, the first pseudonymized dataset to a corresponding cleartext version of the first pseudonymized dataset; and cause the first pseudonymized dataset to be replaced in memory of the user device with the corresponding cleartext version of the first pseudonymized dataset.

### CROSS-REFERENCE TO RELATED APPLICATIONS

This application claims the benefit of U.S. Provisional Patent Application No. 63/493,611, filed Mar. 31, 2023, entitled, “Anonos Dynamic Pseudonymization at the Edge” (hereinafter, “the '611 application”), the disclosure of which is incorporated herein by reference in its entirety. This application is also related to PCT Patent Application No. PCT/US2019/038555, filed Jun. 21, 2019, entitled, “Systems and Methods for Enforcing Privacy-Respectful, Trusted Communications” (hereinafter, “the '555 application”), the disclosure of which is also incorporated herein by reference in its entirety.

### FIELD OF THE INVENTION

This disclosure relates generally to improving data security, privacy, and analysis, and, in particular, to using technological improvements to create and protect a Pseudonymized data set using Anonos Dynamic De-Identification (DDID) principles so that identifiable source data is not ascertainable without access to keys created and managed using DDID principles.

### BACKGROUND

This section is intended to provide a background or context to the invention that is recited in the claims. The description herein may include concepts that could be pursued, but which are not necessarily ones that have been previously conceived, implemented or described. Therefore, unless otherwise indicated herein, what is described in this section is not prior art to the description and claims in this application and is not admitted to be prior art by inclusion in this section.

There are certain inherent conflicts between: (i) the goal of parties to maximize the value of data and their goal of respecting privacy rights of individuals; (ii) the goal of individuals to protect their privacy rights and their goal of benefiting from highly personalized offerings; and (iii) the goal of U.S. and international government agencies to facilitate research and commerce and their goal of safeguarding rights of citizens.

The development, emergence and widespread adoption of computer networks, internets, intranets and supporting technologies has resulted in the wide-spread availability of cost-effective technology to collect, transmit, store, analyze and use information in electronic formats. As a result, entities now have the ability to readily collect and analyze vast amounts of information. This has created tensions between: (a) the increasing quantity of information available to qualify prospects, develop personalized/customized offerings for potential customers and/or conduct health-related or other research; and (b) decreasing security, anonymity and privacy for individuals who often are not aware of the existence of many data elements that may be traced back to them, and over which they often have little or no effective control.

Data elements may be collected both online and offline (both “born digital” and “born analog” and converted into digital format at a later date) through a variety of sources including, but not limited to, activity on social networking sites, electronic or digital records, emails, participation in rewards or bonus card programs that track purchases and locations, browsing or other activity on the Internet, and activity and purchases at brick-and-mortar stores and/or on e-commerce websites. Merchants, medical-related and other service providers, governments, and other entities use this tremendous amount of data that is collected, stored, and analyzed to suggest or find patterns and correlations and to draw useful conclusions, e.g., which types of customers (and/or which particular customers) to direct targeted advertising efforts towards. This data is sometimes referred to as “big data,” due to the extensive amount of information entities may now gather. With big data analytics, entities may now unlock and maximize the value of data. One example may involve non-health related entities engaging in behavioral marketing (with materials created for distribution being customized in an attempt to increase the correlation with the preferences pertaining to a particular recipient party), and another example may involve health-related entities accessing big data to conduct medical research. However, with behavioral marketing and big data analytics, related parties now have a much lower level of privacy and anonymity.

Attempts at reconciling the conflict between privacy/anonymity and value / personalization/research have often historically involved using alternative identifiers rather than real names or identifying information. However, these alternative identifiers are generally statically assigned and persist over time. Static identifiers are more easily tracked, identified, and cross-referenced to ascertain true identities, and they may be used to ascertain additional data about subjects associated with data elements without the consent of related parties. Privacy and information experts have expressed concerns that re-identification techniques may be used with data associated with static identifiers and question whether data that is identifiable with specific computers, devices or activities (i.e., through associated static identifiers) can in practice be considered anonymous or maintained in a protected state of anonymity. When an identifier does not change over time, adversarial entities have unlimited time to accrete, analyze and associate additional or even exogenous data with the persistent identifier, and thus to determine the true identity of the subject and associate other data with the true identity. In addition, unlimited time provides adversarial entities with the opportunity to perform time-consuming brute-force attacks that can be used against any encrypted data.

Many potential benefits from artificial intelligence (AI) big data have not been fully realized due to ambiguity regarding ownership/usage rights of underlying data, tensions regarding privacy of underlying data, and consequences of inaccurate analysis due to erroneous data collected from secondary (versus primary) sources and/or inferred from activities of parties without active participation of, or verification by, said parties. Moreover, consumers are now frequently demanding selective and variable controls that enable increased engagement with trusted business entities, while protecting personal information from misuse by unauthorized or non-trusted business entities. (As used herein, “business entities” can refer to businesses or organizations of any kind, including for-profit organizations, not-for-profit organizations, governmental entities, NGOs (non-governmental organizations), or any third-party entity.) At the same time, business entities are facing the need to overcome potential legal and privacy challenges, while complying with evolving legal and privacy guidelines (e.g., without limitation, the EU General Data Protection Regulation (GDPR), the EU AI Act, and the California Consumer Privacy Act (CCPA)), regulations, and/or laws to unlock digital economic growth in a societally-beneficial way, i.e., such that Data Subject protections are increased, while opportunities for business entities to reach Data Subjects having interest in relevant products and services are also increased, thus increasing those businesses' return on investment in advertising and marketing costs.

GDPR Article 4(5) defines “Pseudonymization” as requiring separation of the information value of data from the risk of re-identification. To benefit from GDPR statutory/regulatory incentives and rewards for pseudonymization, this separation is necessary. Replacing multiple occurrences of the same personal data elements (e.g., name of a Data Subject) with “static” (or persistent) tokens fails to separate the information value of data from the risk of re-identification because re-identifying correlations and linkage attacks (aka the “Mosaic Effect”) are possible due to “static” (or persistent) identifiers being used instead of dynamic de-identifiers.

Static tokenization approaches to protecting data use persistent identifiers. By searching for a particular, tokenized string that repeats itself within or across databases, a malicious actor or interloper can gain enough information to unmask the identity of a data subject. This is an increasing scope problem for analytics and other processes that combine and blend internal and external data sources. By contrast, if a data element is replaced each time it is stored with a different pseudonymized DDID, where each different DDID bears no algorithmic relationship to the others, the same malicious actor or interloper can no longer determine that the DDIDs belong or relate to the same data subject—let alone uncover a data subject's name or other identifying information.

What are needed are systems, methods and devices that overcome the limitations of static and/or persistent privacy/anonymity and security systems and improve the accuracy of data for exchange, collection, transactions, analysis and other uses. Put another way, privacy/anonymity-enhancing technologies, such as those described herein, can help to reconcile the tensions between consumers' desires for enhanced privacy and business entities' desires for access to relevant consumer information, e.g., by providing tools that enable the ability of an authorized user to unlock the “true” meaning of such information only to the extent necessary, and only in certain situations, e.g., only during a particular time interval and/or in a particular context, to deliver targeting advertising, marketing, or other business communications to a particular “type” or “cohort” of Data Subject, while still protecting the individual identities of such Data Subjects, unless or until such Data Subjects agree to reveal their identities and, even then, only for the duration of time, context, or limitation of place or geography, or fit or completion of purpose during which such agreement continues to be applicable.

### SUMMARY

Embodiments disclosed herein may improve data privacy and security by providing a web-based platform and/or an application, e.g., a browser-based application, that provides a user-friendly and efficient way to dynamically pseudonymize cleartext values, e.g., with context-sensitive DDIDs, and to replace DDIDs serving as pseudonyms with cleartext values, such as on a webpage, e.g., by storing them only locally on an individual user's device.

The application may include an optional consent layer to reveal cleartext only to authorized individuals and an optional selective and variable disclosure layer that: (a) does not reveal, (b) reveals everything, (c) reveals a portion, or (d) reveals a variant of the original data based on variables, such as the user, use case, time, location, jurisdiction, etc. The application can also be configured to pseudonymize data on all web pages, or on a specific list of web pages.

The systems, frameworks, and, if desired, other modules disclosed herein, may be implemented in program code executed by a processor, or in another computer. The program code may be stored on a computer readable medium, accessible by the processor. The computer readable medium may be volatile or non-volatile, and it may be removable or non-removable. The computer readable medium may be, but is not limited to, RAM, ROM, solid state memory technology, Erasable Programmable ROM (“EPROM”), Electrically Erasable Programmable ROM (“EEPROM”), CD-ROM, DVD, magnetic cassettes, magnetic tape, magnetic disk storage or other magnetic or optical storage devices.

In certain embodiments, privacy clients may reside in or be implemented using “smart” devices (e.g., wearable, movable or immovable electronic devices, generally connected to other devices or networks via different protocols such as Bluetooth, NFC, Wi-Fi, 3G, Long Term Evolution (LTE), New Radio (NR), etc., that can operate to some extent interactively and autonomously), smartphones, tablets, notebooks and desktop computers, and privacy clients may communicate with one or more servers that process and respond to requests for information from clients, such as requests regarding data attributes, attribute combinations and/or data attribute-to-Data Subject associations (wherein a Data Subject refers to any individual person who can be identified, directly or indirectly, via an identifier, or combinations of identifiers, related to a name, an ID number, location data, or via factors specific to the person's physical, physiological, genetic, mental, economic, cultural or social identity, location, behavior or attribute).

In certain other embodiments, enforcement of context-sensitive controls may occur at the network edge, i.e., to intercept and transform data, whether it's being introduced as input or leveraged as output. Such transformation may be executed through either: (i) policy-governed context sensitive protection controls for incoming data; or (ii) policy-regulated context-sensitive disclosure controls for outgoing data.

Through these context-sensitive controls, data visibility for each recipient can be adjusted dynamically, e.g., according to predefined policy parameters such as purpose, timing, location, or other critical factors. This allows for an unrestricted array of selective and variable disclosures, adapts to numerous authorized users, and accommodates an extensive range of policy constraints. At the network edge, distinct policy applications can unveil varied interpretations of the same data, refining data transparency for each user based on their authorized context of data utilization. Specific data exposure can be minimized to support designated utilizations, ensuring that data is disclosed solely as permitted by relevant subjects or authorized entities.

Furthermore, multiple stakeholders can access and re-interpret diverse sets of data based on their legitimate data rights, validated through identity checks, authentication services, and/or contextual parameters. This ensures that various entities obtain distinct perspectives of the fundamental data, contingent on their access privileges.

Other embodiments of the disclosure are described herein. The features, utilities and advantages of various embodiments of this disclosure will be apparent from the following more particular description of embodiments as illustrated in the accompanying drawings.

### BRIEF DESCRIPTION OF THE DRAWINGS

FIG. 1 illustrates a block diagram, which shows a system for performing dynamic pseudonymization at the network edge, in accordance with one or more embodiments disclosed herein.

FIG. 2 illustrates a flowchart, showing a method of performing dynamic pseudonymization at the network edge, in accordance with one or more embodiments disclosed herein.

FIG. 3 illustrates a block diagram of an example of a programmable device for implementing techniques for dynamic pseudonymization, in accordance with one or more embodiments disclosed herein.

FIG. 4 illustrates a block diagram illustrating a network of clients and a server for implementing techniques for dynamic pseudonymization, in accordance with one or more embodiments disclosed herein.

### DETAILED DESCRIPTION

Societies in the digital era are now faced with the challenge of striking a balance between the benefits that can be obtained by freely sharing and analyzing personal data, and the dangers that this practice poses to the privacy of the individuals whose data is concerned. Replacing original and potentially sensitive data with “pseudonymized data,” i.e., personal data that has been processed in such a manner that the personal data can no longer be attributed to a specific data subject without the use of additional information (provided that such additional information is kept separately and is subject to technical and organizational measures to ensure that the personal data are not attributed to an identified or identifiable natural person), is one of the approaches that attempt to resolve this tension.

The systems and techniques described herein can serve to give users a more user-friendly capability to protect their data using pseudonymization techniques, such as the aforementioned Anonos DDID principles.

For example, according to some implementations, a browser application may be implemented as a software program that can be installed on a user device and run on various web browsers, such as Google Chrome, Firefox, Safari, and Edge. The application may provide a user interface that allows users to connect to an instance of a web-based platform (also referred to herein as the “Data Embassy” platform) to unlock data protection capabilities locally in their user device/web browser. The user interface can easily be accessed, e.g., by clicking on a button or icon on the web browser toolbar or next to a form input field.

Continuing with this example implementation, when the user clicks on the button or icon, the application may perform one or more of the following operations. (1) Display a dialog box that prompts the user to enter Data Embassy platform connection information and other configuration information. (2) When the user is ready to protect their data, they may click on a “Protect” button (or other suitable user interface element indicating the user's desire to initiate data pseudonymization controls), and the application may dynamically replace the corresponding value(s) with DDIDs that serve as pseudonyms (i.e., textual or visual values generated either locally by the application or by the remote Data Embassy software platform). (3) To reverse the protections, the user may click on a “Reverse” button (or other suitable user interface element indicating the user's desire to terminate the use of the data pseudonymization controls), and the application replaces the corresponding DDIDs used as pseudonyms(s) with the original (or otherwise selectively or variably obscured) values generated either locally by the application or by the remote Data Embassy platform. (4) The user can configure their own data protection and/or data privacy settings that allow selective disclosure/obscuring based on the use case, time, location, jurisdiction, etc. (5) The application can retrieve organizational policy settings that allow selective and variable protection, disclosure or obscuring based on variables, such as the use case, time, location, jurisdiction, etc. (6) The application can be configured to work on a specific web page or list of web pages. (This can be useful for users or organizations who want to protect/reveal data only on certain websites or web pages. The user can specify a list of web pages by, for example, entering the relevant URLs in the application's settings.)

### System and Method for Performing Dynamic Pseudonymization at the Network Edge

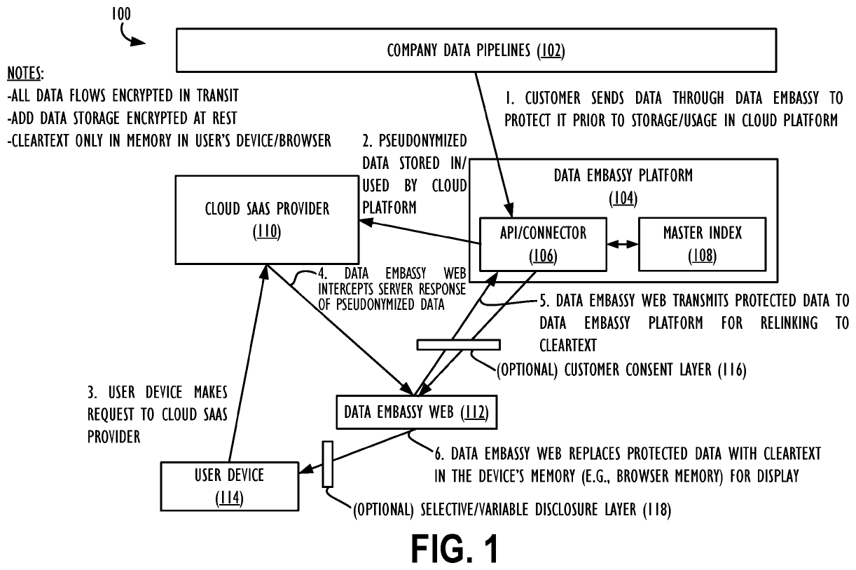

Turning now to FIG. 1, a block diagram 100 is shown, which illustrates a system for performing dynamic pseudonymization at the network edge. In some cases, the system may obtain data from an initial data pipeline, such as company data pipeline 102. In such cases, as shown at Step 1 in FIG. 1, a customer may send the data through the Data Embassy web-based platform 104 to protect it prior to storage in a cloud platform (e.g., as represented by Cloud SaaS Provider 110 in FIG. 1) and/or prior to use in a cloud application, including but not limited to AI/LLM agents, APIs, and/or other types of web-based applications. As also indicated on FIG. 1, in this example, all data flows may be encrypted both in transit and at rest, and the cleartext values of the protected data set may exist only in memory, e.g., in a user's browser/web application.

Next, at Data Embassy Platform 104, an API/Connector module 106 may be used to get and send the data that is to be protected (and, later, which has been protected). In some cases, Data Embassy Platform 104 may further comprise a Master Index 108, which securely houses the cleartext values of the protected data along with additional information that both enables the ability to replace DDIDs with the associated cleartext values.

Next, as shown at Step 2 in FIG. 1, the pseudonymized data produced by Data Embassy Platform 104 may be sent to and stored at Cloud SaaS Provider 110. In this example, as shown at Step 3 in FIG. 1, a User Device 114 may next make a request to Cloud SaaS Provider 110 for some (or all) of the protected data. However, at Step 4 in FIG. 1, a Data Embassy Web client 112 may intercept the Cloud SaaS Provider 110 server's response (i.e., which would comprise the pseudonymized data stored at Cloud SaaS Provider 110 in Step 2), and instead, at Step 5 in FIG. 1, transmit the protected data to the Data Embassy Platform 104 for relinking with the corresponding cleartext version of the protected data. Once relinked, the data may be transmitted back to the Data Embassy Web client 112. According to some implementations, an optional customer consent layer 116 may be implemented by the Data Embassy Platform 104, which explicitly obtains consent from the user at least once before sharing unprotected versions of the protected data back with the User Device 114.

Finally, as shown at Step 6 in FIG. 1, the Data Embassy Web client 112 may replace the protected data intercepted from the server at Step 4 with the cleartext version in the browser memory of User Device 114, e.g., for display to the user and/or transmission to other third parties. According to some implementations, an optional selective and variable disclosure layer 118 may be implemented by the Data Embassy Web client 112, which obtains an indication of a level of disclosure that the user has indicated for the unprotected data. In addition, the level of contextual disclosure may be policy-based, e.g., depending on the dataset, user, or use case. These policies may be defined and stored in the Data Embassy Platform 104 and retrieved by the User Device 114 at run-time. For example, as described above, in some implementations, the optional selective and variable disclosure layer may provide options that: (a) does not reveal, (b) reveals everything, (c) reveals a portion, or (d) reveals a variant of the original data based on variables, such as the use case, time, location, jurisdiction, etc. The user browser application can also be configured to pseudonymize data on all web pages, or on a specific list of web pages, etc.

As may now be appreciated, the technical improvements disclosed herein may have a number of technical benefits for enterprise applications, including: (1) enabling lawful and productive use of SaaS platforms; (2) allowing all cleartext data to be stored securely in customer-owned database; (3) limiting the amount of cleartext personal data stored in cloud platform services; (4) limiting cleartext exposure at the network edge for consumption in a user's device; (5) limiting cleartext stored temporally and only in memory in a user device; (6) no persistent storage of cleartext data; (7) no cleartext data being stored or flowing through the cloud platform; (8) allowing cleartext to only be sent directly to an end user device via SSL; (9) providing an optional consent layer to reveal cleartext data; (10) providing a selective and variable disclosure layer; and (11) allowing use on mobile devices or desktop devices.

As described above, in some implementations, the solutions may be deployed via a browser extension that can intercept requests to cloud servers for data, relink the data via the Data Embassy platform and replace content (e.g., DDIDs acting as pseudonyms) in the webpage HTML. The solutions can also protect outbound data from device to cloud platform in reverse (e.g., for new data input to a website by a user, emails, etc.).

As may now be appreciated, the technical improvements disclosed herein may also have a number of technical benefits for consumer applications, including: (1) enabling private use of public cloud platform solutions; (2) pseudonymizing user personal data (e.g., replacing original images with same dimension images containing DDIDs, such as QR codes, serving as pseudonyms that are relinkable back to the original (or selectively-or variably-obscured) image content; (3) selectively and variably disclosing information to other people who also use Data Embassy; (4) allowing all data and privacy controls to be “owned” by the consumer, rather than a third party or other enterprise; (5) allowing users to not have to rely on SaaS companies for protection or privacy; (6) providing breach-proof data storage; (7) allowing users to control their own data and privacy controls in regards to messaging and other data storage/transmission applications.

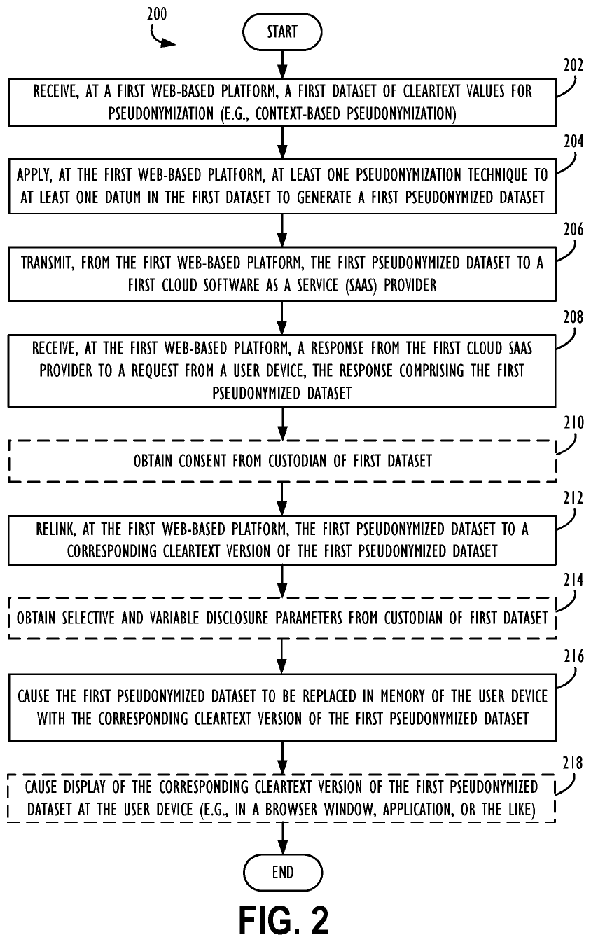

Turning now to FIG. 2, a flowchart, showing a method 200 of performing dynamic pseudonymization at the network edge is illustrated, in accordance with one or more embodiments disclosed herein. First, at Step 202, the method 200 may receive, at a first web-based platform, a first dataset of cleartext values for pseudonymization (e.g., context-based pseudonymization). The first dataset may comprise, e.g., a single datum, multiple data items, textual data, multimedia content, structured or unstructured data, etc. Next, at Step 204, the method 200 may apply, at the first web-based platform, at least one pseudonymization technique to at least one datum in the first dataset to generate a first pseudonymized dataset. As discussed above, Anonos DDID principles, e.g., as detailed in the '555 application, are one examples of pseudonymization techniques that may be applied to the at least one datum in the first dataset.

Next, at Step 206, the method 200 may transmit, from the first web-based platform, the first pseudonymized dataset to a first cloud software as a service (Saas) provider. Next, at Step 208, the method 200 may receive, at the first web-based platform, a response from the first cloud SaaS provider to a request from a user device, the response comprising the first pseudonymized dataset. In some implementations, at Step 210, the method 200 may optionally obtain consent from a custodian of first dataset prior to (e.g., prior to performing the relinking operation at Step 212).

Next, at Step 212, the method 200 may relink, at the first web-based platform, the first pseudonymized dataset to a corresponding cleartext version of the first pseudonymized dataset. In some implementations, at Step 214, the method 200 may optionally obtain context-sensitive selective and variable disclosure parameters from the custodian of the first dataset.

Next, at Step 216, the method 200 may cause the first pseudonymized dataset to be replaced in memory of the user device with the corresponding cleartext version of the first pseudonymized dataset. Finally, in some implementations, at Step 218, the method 200 may optionally cause the display of the corresponding cleartext version of the first pseudonymized dataset at the user device (e.g., in a browser window, application, or the like).

### Example Electronic Devices

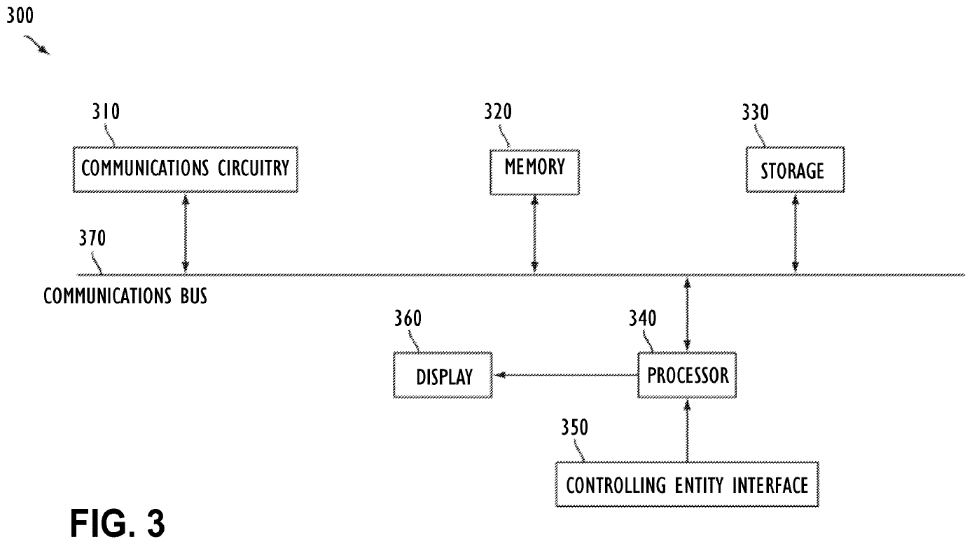

FIG. 3 is an example of a simplified functional block diagram illustrating a programmable device 300 according to one embodiment that can implement one or more of the processes, methods, steps, features or aspects described herein. The programmable device 300 may include one or more communications circuitry 310, memory 320, storage device 330, processor 340, controlling entity interface 350, display 360, and communications bus 370. Processor 340 may be any suitable programmable control device or other processing unit, and it may control the operation of many functions performed by programmable device 300. Processor 340 may drive display 360 and may receive controlling entity inputs from the controlling entity interface 350. An embedded processor provides a versatile and robust programmable control device that may be utilized for carrying out the disclosed techniques.

Storage device 330 may store attribute combinations, software (e.g., for implementing various functions on device 300), preference information, device profile information, and any other suitable data. Storage device 330 may include one or more storage mediums for tangibly recording data and program instructions, including for example, a hard-drive or solid-state memory, permanent memory such as ROM, semi-permanent memory such as RAM, or cache. Program instructions may comprise a software implementation encoded in any desired computer programming language.

Memory 320 may include one or more different types of storage modules that may be used for performing device functions. For example, memory 320 may include cache, ROM, and/or RAM. Communications bus 370 may provide a data transfer path for transferring data to, from, or between at least memory 320, storage device 330, and processor 340.

Although referred to as a bus, communications bus 370 is not limited to any specific data transfer technology. Controlling entity interface 350 may allow a controlling entity to interact with the programmable device 300. For example, the controlling entity interface 350 can take a variety of forms, such as a button, keypad, dial, click wheel, mouse, touch or voice command screen, or any other form of input or user interface.

In one embodiment, the programmable device 300 may be a programmable device capable of processing data. For example, the programmable device 300 may be a device such as any identifiable device (excluding smart phones, tablets, notebook and desktop computers) that have the ability to communicate and are embedded with sensors, identifying devices or machine-readable identifiers (a “smart device”), smart phone, tablet, notebook or desktop computer, or other suitable personal device.

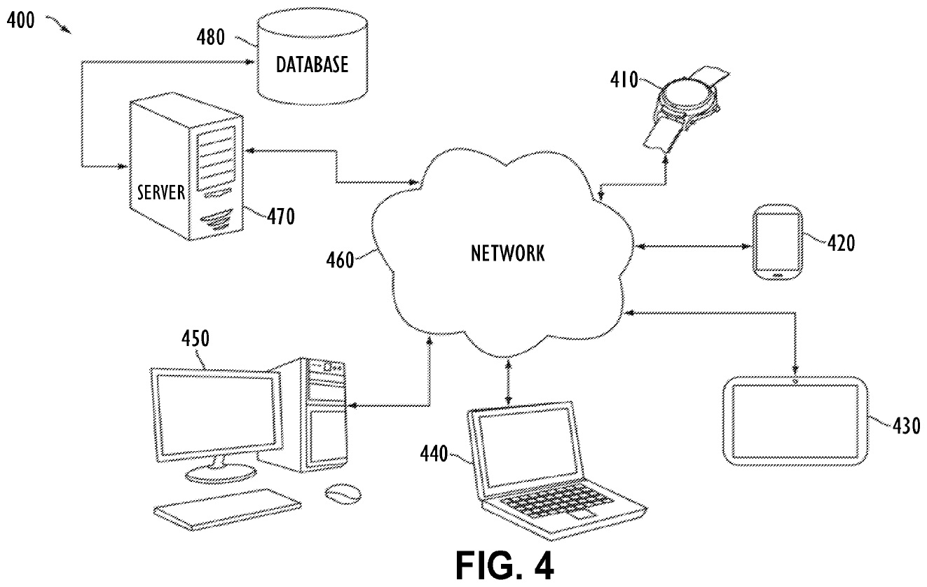

FIG. 4 is an example of a block diagram illustrating a system 400 of networked devices for implementing one or more of the processes, methods, steps, features or aspects described herein. A client application may be implemented on any of the smart device (i.e., wearable, movable or immovable smart devices) 410, smart phone 420, tablet 430, notebook 440, or desktop computer 450, for example. Each of these devices is connected by one or more networks 460 to the privacy server 470, to which is coupled a database 480 for storing synthetic datasets or other relevant information. The database 480 may be any desired form of data storage, including structured databases and non-structured flat files. The privacy server 470 may also provide remote storage for synthetic datasets or other relevant information that has been or will be delivered to the clients on devices 410, 420, 430, 440, 450, or other suitable devices either in the database 480 or in a different database (not shown).

Although a single network 460 is illustrated in FIG. 4, the network 460 may be multiple interconnected networks, and the privacy server 470 may be connected to each of the clients on 410, 420, 430, 440, 450, or other suitable devices via different networks 460. The network 460 may be any type of network, including local area networks, wide area networks, or the global Internet.

### Additional Examples

According to Example 1, a system is disclosed, comprising: a memory having, stored therein, computer program code; and one or more processing units operatively coupled to the memory and configured to execute instructions in the computer program code that cause the one or more processing units to: execute a first web-based platform; receive, at the first web-based platform, a first dataset of cleartext values for pseudonymization; apply, at the first web-based platform, at least one pseudonymization technique to at least one datum in the first dataset to generate a first pseudonymized dataset; transmit, from the first web-based platform, the first pseudonymized dataset to a first cloud software as a service (Saas) provider; receive, at the first web-based platform, a response from the first cloud SaaS provider to a request from a user device, the response comprising the first pseudonymized dataset; relink, at the first web-based platform, the first pseudonymized dataset to a corresponding cleartext version of the first pseudonymized dataset; and cause the first pseudonymized dataset to be replaced in memory of the user device with the corresponding cleartext version of the first pseudonymized dataset.

According to Example 2, a system is accordance with Example 1 is disclosed, wherein the instructions in the computer program code further cause the one or more processing units to: obtain consent from a custodian of the first dataset prior to executing the instructions to relink, at the first web-based platform, the first pseudonymized dataset to a corresponding cleartext version of the first pseudonymized dataset.

According to Example 3, a system is accordance with Example 1 is disclosed, wherein the instructions in the computer program code further cause the one or more processing units to: obtain selective and variable disclosure parameters from a custodian of the first dataset prior to executing the instructions to cause the first pseudonymized dataset to be replaced in memory of the user device with the corresponding cleartext version of the first pseudonymized dataset.

According to Example 4, a system is accordance with Example 3 is disclosed, wherein the selective and variable disclosure parameters comprise at least one of the following options: (a) not revealing any of the cleartext values of the first dataset; (b) revealing all of the cleartext values of the first dataset; (c) revealing a portion of the cleartext values of the first dataset; or (d) revealing a variant of one or more of the cleartext values of the first dataset.

According to Example 5, a system is accordance with Example 1 is disclosed, wherein the instructions in the computer program code further cause the one or more processing units to: display the corresponding cleartext version of the first pseudonymized dataset at the user device.

According to Example 6, a system is accordance with Example 1 is disclosed, wherein the at least one pseudonymization technique comprises dynamically replacing cleartext values with one or more temporally unique, dynamically changing de-identifiers (DDIDs).

According to Example 7, a system is accordance with Example 1 is disclosed, wherein the first dataset is associated with a first set of one or more web pages visited by the user device.

Other Examples include non-transitory program storage devices and/or computer-implemented methods in accordance with Examples 1-7, listed above.

### Additional Comments

While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention. For instance, as a non-limiting example, in alternative embodiments, portions of operations described herein may be re-arranged and performed in different order than as described herein.

It should be appreciated that reference throughout this specification to “one embodiment” or “an embodiment” or “one example” or “an example” means that a particular feature, structure or characteristic described in connection with the embodiment may be included, if desired, in at least one embodiment of the present invention. Therefore, it should be appreciated that two or more references to “an embodiment” or “one embodiment” or “an alternative embodiment” or “one example” or “an example” in various portions of this specification are not necessarily all referring to the same embodiment. Furthermore, the particular features, structures or characteristics may be combined as desired in one or more embodiments of the invention.

It should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed inventions require more features than are expressly recited in each claim. Rather, inventive aspects lie in less than all features of a single foregoing disclosed embodiment, and each embodiment described herein may contain more than one inventive feature.

While the invention has been particularly shown and described with reference to embodiments thereof, it will be understood by those skilled in the art that various other changes in the form and details may be made without departing from the spirit and scope of the invention.

1. A system, comprising:
a memory having, stored therein, computer program code; and
one or more processing units operatively coupled to the memory and configured to execute instructions in the computer program code that cause the one or more processing units to:
execute a first web-based platform;
receive, at the first web-based platform, a first dataset of cleartext values for pseudonymization;
apply, at the first web-based platform, at least one pseudonymization technique to at least one datum in the first dataset to generate a first pseudonymized dataset;
transmit, from the first web-based platform, the first pseudonymized dataset to a first cloud software as a service (Saas) provider;
receive, at the first web-based platform, a response from the first cloud SaaS provider to a request from a user device, the response comprising the first pseudonymized dataset;
relink, at the first web-based platform, the first pseudonymized dataset to a corresponding cleartext version of the first pseudonymized dataset; and
cause the first pseudonymized dataset to be replaced in memory of the user device with the corresponding cleartext version of the first pseudonymized dataset.

2. The system of claim 1, wherein the instructions in the computer program code further cause the one or more processing units to:
obtain consent from a custodian of the first dataset prior to executing the instructions to relink, at the first web-based platform, the first pseudonymized dataset to a corresponding cleartext version of the first pseudonymized dataset.

3. The system of claim 1, wherein the instructions in the computer program code further cause the one or more processing units to:
obtain selective and variable disclosure parameters from a custodian of the first dataset prior to executing the instructions to cause the first pseudonymized dataset to be replaced in memory of the user device with the corresponding cleartext version of the first pseudonymized dataset.

4. The system of claim 3, wherein the selective and variable disclosure parameters comprise at least one of the following options:
(a) not revealing any of the cleartext values of the first dataset;
(b) revealing all of the cleartext values of the first dataset;
(c) revealing a portion of the cleartext values of the first dataset; or
(d) revealing a variant of one or more of the cleartext values of the first dataset.

5. The system of claim 1, wherein the instructions in the computer program code further cause the one or more processing units to:
display the corresponding cleartext version of the first pseudonymized dataset at the user device.

6. The system of claim 1, wherein the at least one pseudonymization technique comprises dynamically replacing cleartext values with one or more temporally unique, dynamically changing de-identifiers (DDIDs).

7. The system of claim 1, wherein the first dataset is associated with a first set of one or more web pages visited by the user device.

8. A non-transitory program storage device comprising instructions stored thereon to cause one or more processors to:
execute a first web-based platform;
receive, at the first web-based platform, a first dataset of cleartext values for pseudonymization;
apply, at the first web-based platform, at least one pseudonymization technique to at least one datum in the first dataset to generate a first pseudonymized dataset;
transmit, from the first web-based platform, the first pseudonymized dataset to a first cloud software as a service (Saas) provider;
receive, at the first web-based platform, a response from the first cloud SaaS provider to a request from a user device, the response comprising the first pseudonymized dataset;
relink, at the first web-based platform, the first pseudonymized dataset to a corresponding cleartext version of the first pseudonymized dataset; and
cause the first pseudonymized dataset to be replaced in memory of the user device with the corresponding cleartext version of the first pseudonymized dataset.

9. The non-transitory program storage device of claim 8, wherein the instructions further cause the one or more processing units to:
obtain consent from a custodian of the first dataset prior to executing the instructions to relink, at the first web-based platform, the first pseudonymized dataset to a corresponding cleartext version of the first pseudonymized dataset.

10. The non-transitory program storage device of claim 8, wherein the instructions in the computer program code further cause the one or more processing units to:
obtain selective and variable disclosure parameters from a custodian of the first dataset prior to executing the instructions to cause the first pseudonymized dataset to be replaced in memory of the user device with the corresponding cleartext version of the first pseudonymized dataset.

11. The non-transitory program storage device of claim 10, wherein the selective and variable disclosure parameters comprise at least one of the following options:
(a) not revealing any of the cleartext values of the first dataset;
(b) revealing all of the cleartext values of the first dataset;
(c) revealing a portion of the cleartext values of the first dataset; or
(d) revealing a variant of one or more of the cleartext values of the first dataset.

12. The non-transitory program storage device of claim 8, wherein the instructions further cause the one or more processing units to:
display the corresponding cleartext version of the first pseudonymized dataset at the user device.

13. The non-transitory program storage device of claim 8, wherein the at least one pseudonymization technique comprises dynamically replacing cleartext values with one or more temporally unique, dynamically changing de-identifiers (DDIDs).

14. The non-transitory program storage device of claim 8, wherein the first dataset is associated with a first set of one or more web pages visited by the user device.

15. A computer-implemented method, comprising:
executing a first web-based platform;
receiving, at the first web-based platform, a first dataset of cleartext values for pseudonymization;
applying, at the first web-based platform, at least one pseudonymization technique to at least one datum in the first dataset to generate a first pseudonymized dataset;
transmitting, from the first web-based platform, the first pseudonymized dataset to a first cloud software as a service (Saas) provider;
receiving, at the first web-based platform, a response from the first cloud SaaS provider to a request from a user device, the response comprising the first pseudonymized dataset;
relinking, at the first web-based platform, the first pseudonymized dataset to a corresponding cleartext version of the first pseudonymized dataset; and
causing the first pseudonymized dataset to be replaced in memory of the user device with the corresponding cleartext version of the first pseudonymized dataset.

16. The computer-implemented method of claim 15, further comprising:
obtaining consent from a custodian of the first dataset prior to relinking, at the first web-based platform, the first pseudonymized dataset to a corresponding cleartext version of the first pseudonymized dataset.

17. The computer-implemented method of claim 15, further comprising:
obtaining selective and variable disclosure parameters from a custodian of the first dataset prior to causing the first pseudonymized dataset to be replaced in memory of the user device with the corresponding cleartext version of the first pseudonymized dataset.

18. The computer-implemented method of claim 17, wherein the selective and variable disclosure parameters comprise at least one of the following options:
(a) not revealing any of the cleartext values of the first dataset;
(b) revealing all of the cleartext values of the first dataset;
(c) revealing a portion of the cleartext values of the first dataset; or
(d) revealing a variant of one or more of the cleartext values of the first dataset.

19. The computer-implemented method of claim 15, further comprising:
displaying the corresponding cleartext version of the first pseudonymized dataset at the user device.

20. The computer-implemented method of claim 15, wherein the at least one pseudonymization technique comprises dynamically replacing cleartext values with one or more temporally unique, dynamically changing de-identifiers (DDIDs).
